(19) United States
(12) Patent Application Publication
(10) Pub. No.: US 2023/0106054 A1
(43) Pub. Date: Apr. 6, 2023

(54) LOW-COST INTERNET-OF-THINGS DEVICE FOR ON-SITE AND REGIONAL EARTHQUAKE EARLY WARNING

(71) Applicant: Vivien He, Rancho Palos Verdes, CA (US)

(72) Inventor: Vivien He, Rancho Palos Verdes, CA (US)

(21) Appl. No.: 17/450,058

(22) Filed: Oct. 5, 2021

(51) Int. Cl. G08B 21/10; G08B 3/10; G01V 1/00; G01V 1/18; G16Y 40/10; H04W 4/90

(52) U.S. Cl. CPC G08B 21/10; G08B 3/10; G01V 1/008; G01V 1/181; G16Y 40/10; H04W 4/90; G01V 2210/42

(57) ABSTRACT

A low-cost Internet-of-Things (IoT) earthquake early warning (EEW) device can be deployed at homes, business facilities, and field locations to provide on-site warning and alert regional subscribers. The IoT device is integrated with a sensor, such as a geophone, for ground motion sensing, a single board computer, an analog-to-digital converter, an alert, wireless connectivity, and custom-designed packaging. A custom software application can control the device, detect earthquakes, and issue alerts. The device can run automatically and can be managed remotely. A collection of devices can form a network to provide even more lead time in EEW. For example, if one device detects an earthquake in northern Los Angeles metro area and alerts another device/user/subscriber of the warning service in southern Los Angeles, then the latter gets extra warning time because it could take about 5 to 10 seconds for seismic waves to travel from northern to southern Los Angeles.

### BACKGROUND OF THE INVENTION

### 1. Field of the Invention

Embodiments of the invention relate generally to seismic warning devices. More particularly, embodiments of the invention relate to a low-cost device that can provide on-site and regional early warnings of earthquakes.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Earthquakes are major natural disasters that impact a significant population of the world. Earthquakes caused the most fatalities among all the natural disasters globally in the 20-year period from 1998 to 2017. During the 20 years, earthquakes caused 747,000 deaths, 125 million injuries or displacements, and US$660 billion in economic losses. For example, the 2010 Mw 7.0 Haiti earthquake left about 300,000 people dead or missing, 300,000 injured, 1.3 million homeless, and US$7 to 14 billion in damages which are about 100% to 200% of Haiti's gross domestic product.

Earthquakes are not uniformly distributed globally. They are concentrated along fault surfaces where tectonic plates interact, therefore greatly impacting countries near faults, such as Japan, Indonesia, USA, China, Chile, and the like. Within the United States, Alaska has the most earthquakes, followed by California, with Nevada and Hawaii essentially tied for the third place. Earthquakes in Alaska, California, and Nevada are mainly driven by plate tectonic processes, while those in Hawaii are driven by volcanic processes. While Alaska has the highest number of earthquakes, California has more earthquakes that cause damages than any other state. The San Andreas Fault System, stretching about 1,200 km through California, accommodates a significant fraction of motion between the North American and Pacific Plates. There is a high probability of major earthquakes that are overdue on the Southern San Andreas fault system in Southern California.

There are three types of seismic waves generated by earthquakes: the first two, P (primary) waves and S (secondary) waves, are body waves which travel through Earth's interior. The third are surface waves, which travel in the layers just below Earth's surface. P waves alternately compress and stretch the materials in the direction of propagation. S waves shake materials perpendicular to the direction of propagation. Generally, in solid Earth materials, P waves travel about 70% faster than S waves, and S waves are about 10% faster than surface waves. Therefore, P waves arrive first in an earthquake, followed by S waves and surface waves. On the other hand, surface waves have greater amplitudes than S waves, while S waves have greater amplitudes than P waves. In addition, surface waves and S waves maintain their peak amplitudes longer, therefore can cause more damage than P waves. Timely detection of P wave arrival can provide a warning for the later and more destructive S waves and surface waves.

Earthquakes cannot be predicted before they occur, but an alternative approach to earthquake prediction is earthquake early warning (EEW). EEW systems rapidly detect an earthquake after it starts, then issue either an on-site warning at the detection location in anticipation of additional and/or stronger shaking, or a regional warning for nearby areas that will be impacted soon. EEW leverages the feature that (1) the less-destructive P waves arrive before the more-destructive S waves and surface waves, and (2) that electronic communications travel faster than earthquake waves. EEW systems could provide potential warning times of seconds to tens of seconds.

EEW systems are well developed in some countries such as Japan, which is subject to high potential for earthquakes in densely populated areas. Japan has built a nationwide public EEW network over many years which not only can provide public alerts but also send control signals for automated responses such as stopping trains. Another example of EEW is the Seismic Alert System for Mexico City, which can provide as much as 60 seconds of early warning for an earthquake that reaches Mexico City from the subduction zone along the Pacific coast.

The United States does not have a national EEW system, but there is a regional EEW system called ShakeAlert which covers the west coast states of California, Oregon, and Washington. ShakeAlert is led by the US Geological Survey (USGS) in partnership with universities and government agencies, which rolled out ShakeAlert 1.0 in 2016 and ShakeAlert 2.0 in 2018. Using historic waveform data as a test, ShakeAlert 2.0 has an average false alert rate of 8% and missed alert rate of 16% for M 5+ earthquakes. ShakeAlert is still in the testing phase with regional public users and pilot institutional partners. As of March 2020, the ShakeAlert network has over 900 seismic stations contributing data, making the network about 63% complete according to the plan. Additional new stations need to be installed to increase network density, especially in high-risk areas. Some existing stations need to be upgraded. Long-term public funding to operate and maintain the ShakeAlert system has not yet been secured, which could impact its network growth speed and sustainability.

Current regional EEW networks have limitations and challenges for both technical and practical reasons. First, there is always a blind zone around the earthquake epicenter, where warning is the most needed but cannot be provided. This is due to the time lags from earthquake onset to detection at the closest seismic stations, to issuing a warning, and to receipt of the warning by the end user. The size of the blind zone can be significant, driven by the distance of the nearest seismic stations from the epicenter and communication latency. Secondly, there is the issue of source determinism, which is how well the size of an earthquake can be characterized with only data from the beginning of rupture onset. There is research based on both theoretical study and observations suggesting that small and large earthquakes are indistinguishable at their onsets and thus EEW may not reliably estimate an earthquake's magnitude quickly at its beginning. Thirdly, even when earthquake magnitude and origin are accurately determined quickly, it is challenging to predict ground motion intensity at user's location, leading to either missed alerts due to underestimation or false alerts due to overestimation. For example, there were two significant earthquakes near Ridgecrest, Calif. in 2019, one of magnitude Mw 6.4 and the other Mw 7.1. For both events, ShakeAlert had 6.9 seconds of latency between earthquake origin time and alert creation. Public alerts were not issued due to the alert threshold set too high (for the Mw 6.4 event) or the earthquake magnitude and subsequent ground motions being underestimated (for the Mw 7.1 event). Fourthly, seismic stations are costly, leading to lower density, higher latency, and increased blind zones. For example, it costs on average $52,600 to install a ShakeAlert station with strong-motion detection, and $64,600 for those with both strong-motion and broadband detections, excluding operation and maintenance costs.

Seismometers based on MEMS (micro-electro-mechanical systems) accelerometers have lower manufacturing cost than conventional seismometers. These MEMS-based devices have been used to build higher density seismic networks for EEW or seismic studies, such as the Quake-Catcher Network (QCN), the Community Seismic Network (CSN), and P-Alert. While MEMS devices have lower manufacturing cost, the total cost of ownership of MEMS-based seismic stations may not be significantly cheaper than traditional ones due to costs for installation, operation, and maintenance. In addition, MEMS-based seismometers are best suitable only for strong motion detection and have high noise floors.

MyShake is another type of EEW network based on MEMS accelerometers. It crowdsources data from the accelerometers in users' smartphones globally through an app. MyShake is still in its infancy and faces challenges such as interference from the users' daily activities, high noise floor, poor or inconsistent coupling between smartphone and the ground, and lack of users or usage of the required smartphone app.

There are also seismometers like Raspberry Shake devices that are based on both geophones and MEMS accelerometers. These devices typically cost hundreds of dollars, mainly target citizen scientists, and are more suited for characterization of local and regional events than teleseismic events. They are not designed or priced for consumers for on-site earthquake early warning applications.

In view of the foregoing, there is a need for a low-cost EEW device that can be mass deployed in homes and business facilities for on-site warning and can also send alerts to regional subscribers.

### SUMMARY OF THE INVENTION

Embodiments of the present invention provide a method for providing an early earthquake warning (EEW) to a user comprising disposing an EEW device at a location, typically at or near the user's location; detecting ground motion with a sensor disposed in the device; processing data from the sensor in an analog-to-digital converter (ADC) in the device; sending data from the ADC to a single board computer; providing an alert, such as sounding an alarm in the event when ground motion is determined to be, by the single board computer, above a predetermined threshold or meeting predefined criteria; and alerting other users of the detected event by sending out messages to respective computing devices of the other users.

In some embodiments, the method further includes stopping other devices or appliances, after detection of the event, when ground motion is determined to be, by the single board computer, above the predetermined threshold or meeting predefined criteria.

In some embodiments, the method further includes deactivating the alarm by depressing a button on the EEW device or remotely controlled wireless or over the internet.

Embodiments of the present invention further provide a method for providing an early earthquake warning (EEW) to a user comprising disposing an EEW device at or near a user's location; detecting ground motion with a sensor disposed in the EEW device; processing data from the sensor on an analog-to-digital converter (ADC) disposed on a printed circuit board in the EEW device; sending data from the ADC to a single board computer disposed in the EEW device; sounding an alarm when ground motion is determined to be, by the single board computer, above a predetermined threshold or predefined criteria, the alarm including at least a buzzer disposed on the printed circuit board; alerting other users of the detected vertical ground motion by sending out messages to respective computing devices of the other users; and encasing the single board computer, the printed circuit board and the sensor in a single housing.

Embodiments of the present invention also provide an early earthquake warning (EEW) device comprising a printed circuit board having an analog-to-digital converter (ADC) disposed thereon; a buzzer alarm disposed on the printed circuit board; a single board computer coupled, via an interface, to the printed circuit board; a sensor, such as a geophone, electrically connected to the printed circuit board; and a housing containing the buzzer alarm, the single board computer, the geophone and the printed circuit board, wherein the geophone detects ground motion and sends a motion signal to the ADC; the ADC operates on the motion signal to send a converted signal to the single board computer; the single board computer having a processor operable to compare the converted signal to a predetermined threshold or predefined criteria and to sound the buzzer alarm when the converted signal is above a predetermined threshold or meeting predefined criteria, indicating stronger and/or additional ground motion will occur at the user's location.

In some embodiments, the housing has dimensions of about 1.5 inches to about 4 inches in length, depth and height.

In some embodiments, the housing includes a plurality of openings to fluidly connect the ADC, the printed circuit board, and the single board computer with an external environment, which also allows adding accessories such as GPS, ethernet adapter, battery, or power bank.

These and other features, aspects and advantages of the present invention will become better understood with reference to the following drawings, description, and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of an internet of things (IoT) earthquake early warning (EEW) device according to an exemplary embodiment of the present invention;

FIG. 2 illustrates a back view of a printed circuit board (PCB) with an analog-to-digital converter (ADC) chip, surface-mount capacitors and resistors, buzzer alarm, button switch, general purpose input/output (GPIO) interface, and geophone soldering port, usable in the IoT EEW device of FIG. 1;

FIG. 3 illustrates a front view of the PCB of FIG. 2;

FIG. 4 illustrates a graph showing the ADC noise level, without external circuit, was measured to be 0.058 μV in root mean square (RMS) value;

FIG. 5 illustrates a graph showing the ADC noise level with the geophone and signal conditioning circuit connected was measured to be 2.0 μV in root mean square (RMS) value, indicating that the geophone and circuit introduced noise to the system, and the noise is still very low for EEW applications;

FIG. 6 illustrates a graph showing temperature profiles of the device from power-up to continuous operation for 2 hours at 100 samples per second and PGA amplification of 32, where, under a constant ambient temperature of 24° C., the single board computer (Raspberry Pi® in this case) CPU temperature stabilized at 40.1° C. and the ADC chip temperature stabilized at 33.6° C., both of which were well within the specified operating ranges of the chips;

FIG. 7 illustrates a seismic helicorder plot generated by the IoT EEW device of FIG. 1 for the 24-hour period on Sep. 19, 2020 UTC around the time of the M 4.5 earthquake, illustrating that the earthquake signal was significantly higher than both the baseline noise of the system and the frequent, mostly weaker and more brief, ground motions generated by human activities at or near the user's location;

FIG. 8 illustrates a seismic waveform chart generated by the IoT EEW device of FIG. 1 of the M 4.5 earthquake on Sep. 19, 2020 UTC, with an epicenter about 40 km from the user's location; and

FIG. 9 illustrates a vertical channel waveform for the M 4.5 earthquake on Sep. 19, 2020 UTC, as detected by the nearest high-performance seismometer at the RPV station in the Southern California Seismic Network, which was 4 km away from the user's location, where the waveforms from the IoT EEW device in FIG. 8 and those from the high-performance seismometer are comparable.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a low-cost Internet-of-Things (IoT) earthquake early warning (EEW) device that can be deployed at homes, business facilities, and field locations to provide on-site warning and alert regional subscribers. The IoT device is integrated with a ground motion sensor, such as a geophone, for ground motion sensing, a single board computer, an analog-to-digital converter (ADC), an alarm, Wi-Fi connectivity, and custom-designed packaging. A custom software applicant can control the device, detect earthquakes, and issue alerts. The device can run automatically upon power up and can be managed remotely on a smartphone or computer. A collection of devices can form a network to provide even more lead time in EEW. For example, if one device detects an earthquake in northern Los Angeles metro area and alerts another device/user/subscriber of the warning service in southern Los Angeles, then the latter gets extra warning time because it could take about 5 to 10 seconds for seismic waves to travel from northern to southern Los Angeles.

The device successfully detected all earthquakes over the magnitude of M 3.0 around Los Angeles metro area since September 2020, and nearby earthquakes down to M 2.3. For earthquakes above the alert threshold set by the user, the device issued EEW alerts by sounding the onboard alarm and sending out text messages to local subscribers. The device produced earthquake waveforms consistent with a nearby official US Geological Survey seismometer in the Southern California Seismic Network.

Aspects of the present invention take a fundamentally different approach to EEW as compared to conventional devices. Instead of the costly, large seismic stations supported by public funding, the device according to embodiments of the present invention is small (typically as a cube having sides from about 1.5 to about 6 inches each, typically from about 1.5 to about 4 inches each, and even as small as about 2 by 2.8 by 2.8 inches) and fits easily into consumers' homes or business facilities (akin to a smart smoke detector) or field locations. The low cost and small size of the device can enable mass adoption of consumers and businesses, which will, in turn, create a much denser network than the current sparsely distributed seismic stations. The higher density of stations of the device can lead to lower latency between earthquake and alert, as well as reducing blind zones where alerts are not received before earthquakes arrive.

Current EEW systems have to project the level of ground motion at a user's location to determine whether or not to alert them, which could lead to missed alerts or false alarms from under/overestimate of ground motion at the user's location. Aspects of the present invention can instead directly measure ground motion at a user's location.

Aspects of the present invention provide an EEW device that is stationed at a user's location (e.g. consumers' home or business facilities or field location), that provides on-site alarm via the integrated buzzer alarm, that provides alert signal for automated responses such as shutting off utilities or stopping machinery, that sends alerts such as text messages or social-media or smartphone App messages to local subscribers of the warning services, and that can be controlled remotely via a smartphone or computer.

The EEW device is “built-for-purpose” which is not meant to detect earthquakes that will not generate an impact for the user (e.g. earthquakes from far away or are of low magnitude), but rather, to detect those that could generate an impact for the user.

A low-cost Internet-of-Things (IoT) EEW device, as discussed in greater detail below, was designed and built, including both hardware and software, and tested to detect earthquakes and issue early warnings. The device is integrated with a geophone to detect ground motion, a single board computer, a high-precision 32-bit analog-to-digital converter (ADC), an alarm, wireless connectivity, and custom-designed software and hardware. To appeal to consumers and help enable mass adoption, the device was built with under $100, where such cost could be further lowered with increased production volume. In an exemplary embodiment, the palm-sized device is about 2.8 inches long, 2.8 inches wide and about 2 inches tall, for example. The device can measure ground motion at 100 samples per second (or at lower or higher sampling rate as needed). The device detected all earthquakes over the magnitude of M 3.0 near Los Angeles metro area, California since September 2020, or nearby earthquakes as low as M 2.3. For example, for the M 4.5 earthquake about 40 km from the user testing site that occurred on Sep. 19, 2020 UTC, the device successfully issued an EEW alert, sounded the onboard alarm, sent out text messages to local subscribers, and produced seismic waveforms consistent with a nearby official USGS seismometer in the Southern California Seismic Network (SCSN).

Compared to traditional regional EEW systems, the device can provide on-site alerts for users in the blind zone and increase warning time for those close to the epicenter. In addition, the device can directly measure a user's ground motion at their location, bypassing the challenge in regional EEW of predicting ground motion at user's location. The device also allows each user to have their own customized settings for alert threshold based on their own tolerance for missed vs. false alarms, instead of uniform settings for all users and local warning subscribers. The IoT device can be connected to the internet via the user's Wi-Fi, for example, which allows it to send out alerts via text messages, generate signals for automated responses, and be remotely managed on a smartphone or computer.

The IoT device has the potential to become the basis of a dense regional EEW network. All devices can be connected to the internet and can communicate with the hub and/or with each other. The low-cost nature of the device encourages mass adoption by consumers and businesses, with the potential to form a dense network. This low-cost IoT EEW device and the consumer-based approach it enables can create great new opportunities for earthquake early warning and seismic study.

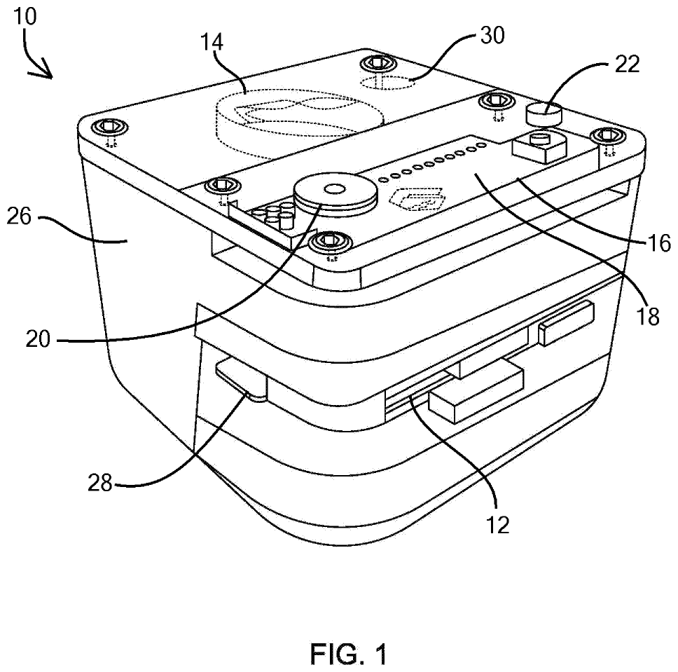

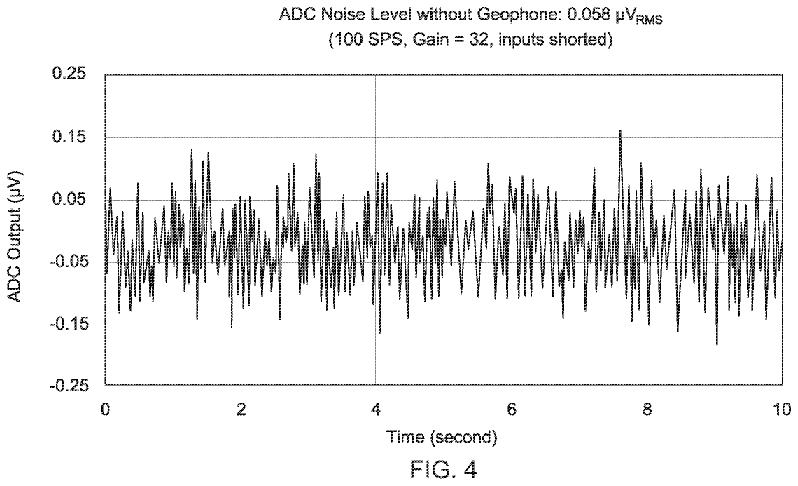

Referring now to FIGS. 1 through 3, an IoT EEW device 10 (also referred to as EEW device 10 or simply device 10) includes a single board computer 12, such as a Raspberry Pi® Zero Wireless single board computer, with wireless connectivity, such as Wi-Fi connectivity. A ground motion sensor, such as a geophone 14, can be used for ground motion sensing. The device 10 can also include a 32-bit precision analog-to-digital converter 16 (ADC) (see FIG. 3), an active buzzer alarm 20 and a button switch 22 for the alarm 20, each mounted on a custom-designed PCB 18 with control and signal processing circuits and a GPIO (general-purpose input/output) interface 24 (see FIG. 3) to connect to the single board computer 12. The components can be mounted in a housing 26 made with, for example, laser-cut cast acrylic layers screwed together with stainless steel screws and standoffs. Software runs on the operating system of the single board computer 12 to control the ADC 16, processes data from the geophone 14, issues earthquake alerts through the onboard buzzer 20 and via text messages and produces standard seismic waveform mini-SEED files. The device 10 can be remotely managed over the internet, either through a smartphone or computer.

Raspberry Pi® Zero Wireless can be used as the single board computer 12, where the device has a 1 GHz CPU and 512 MB RAM, which is sufficient for the instant application and has a low cost. The board size is small, measuring 66.0 mm long, 30.5 mm wide, and 5.0 mm thick. The single board computer 12 can have integrated wireless connectivity, including 802.11 b/g/n wireless LAN (Wi-Fi), Bluetooth® 4.1, and Bluetooth® Low Energy (BLE). The single board computer 12 can have a mini-HDMI port to connect to a monitor and a USB On-The-Go port that can be connected to a keyboard and a mouse. However, in embodiments of the present invention, the device 10 can run the single board computer 12 in the “headless” mode without the need for a monitor, keyboard, or mouse. The device can run automatically upon power up and can be accessed remotely via the secure shell (SSH) network protocol. The single board computer can include a 40-pin GPIO interface allowing it to control and communicate with the ADC 16 and other components of the system. A 16 GB micro-SDHC card 28 can be used to store the operating system, custom software, user configurations, and seismic waveform data. The primary functions of the single board computer 12 in the instant application are to (1) run the operating system which can be based on Debian, a Linux distribution customized for the Raspberry Pi® hardware; (2) operate in the “headless” mode without a monitor or keyboard; (3) connect to the internet through Wi-Fi, for example, which also provides a secure channel (SSH) for remote communications; (4) control the ADC; (5) read geophone output through the ADC and GPIO interface; (6) remove false data and save valid data into a standard seismic miniSEED file; (7) when earthquake ground motion above the threshold set by the user is detected, sound the alarm through the loud onboard buzzer for onsite EEW alert and send out text messages to the local subscribers of the warning service for regional EEW.

A passive geophone 14 can be used to convert vertical ground motion into electric signals. The geophone 14 can be installed vertically and can contain a coil suspended by springs around a permanent magnet. The size of the geophone 14 is small, measuring 25.4 mm in diameter and 36 mm in height, for example. As the coil moves relative to the magnet due to ground motion, an electrical voltage is generated which is proportional to ground velocity, as long as the movement frequency is above the natural frequency of the geophone 14. The geophone 14 used in the device 10 has a natural frequency of 4.5 Hz, which means there is a linear voltage response for seismic waves above this frequency, and lower-frequency signals will have lower response and lower resolution. This frequency threshold can be reduced electronically to extend the linear response range to measure seismic waves from more distant earthquakes that have lower frequencies; however, this is not necessary for EEW applications because distant earthquakes are not noticeable to users. Therefore, a simple passive geophone 14 can be used, which also lowers cost and reduces noise associated with an active circuit.

The analog-to-digital converter 16 (ADC) is used to convert the analog signal output of the geophone 14 to digital. High-end seismometers typically use ADCs with 24-bit resolution and low noise for measurement of weak seismic signals. A 32-bit ADC, Texas Instruments® ADS1262 can be used in the device 10 for its best-in-class resolution and noise performance. The ADS1262 ADC 16 has ultralow noise, as low as 7 nV measured in RMS (root mean square) value. The ADC 16 can have ten channels through an input multiplexer. For the device 10, only two channels are used for differential input from the two outputs of the geophone. The other input pins are connected to the 2.5 V internal voltage reference pin to minimize input leakage. The unused channels provide expansion capacity for future development, for example, to integrate accelerometers to capture strong motion seismic signals. The packaging of the ADC 16 is standard 28-pin TSSOP (thin-shrink small outline package). While the ADC 16 can run up to 38,400 samples per second (SPS), typical seismometers and EEW applications only require 100 SPS, therefore this device runs at 100 SPS. The ADC 16 also has an integrated low-noise programmable gain amplifier (PGA) with an amplification ratio ranging from 1 to 32, which removes the need for an external amplifier for this application. Given the weakness of seismic signals, the device 10 can use the maximum PGA gain of 32, which improves signal-to-noise ratio while still staying in the input range of the ADC. The single board computer 12 communicates with the ADC 16 through a bi-directional SPI serial interface to configurate and control the ADC's operation and to read conversion data. The single board computer 12 can receive the data, perform checksum verification to improve data transfer integrity, then process the data. The ADC 16 can be powered by one of the single board computer's 5V GPIO outputs and can run in the single 5V operation mode.

The onboard alarm is an active buzzer 20 which generates a loud beeping sound over 80 dB when earthquake ground motion above alert threshold or meeting predefined criteria is detected. The operating voltage of the buzzer 20 is 3V, which can be driven by an output of the single board computer 12 and can be programmed to generate different sound patterns. The buzzer 20 is small, measuring, for example, 12 mm in diameter and 9.5 mm in height.

The buzzer alarm can be turned off by an onboard button switch 22 which is a momentary tactile push button, for example. Alternatively, the buzzer 20 can be turned off remotely through a smartphone or computer.

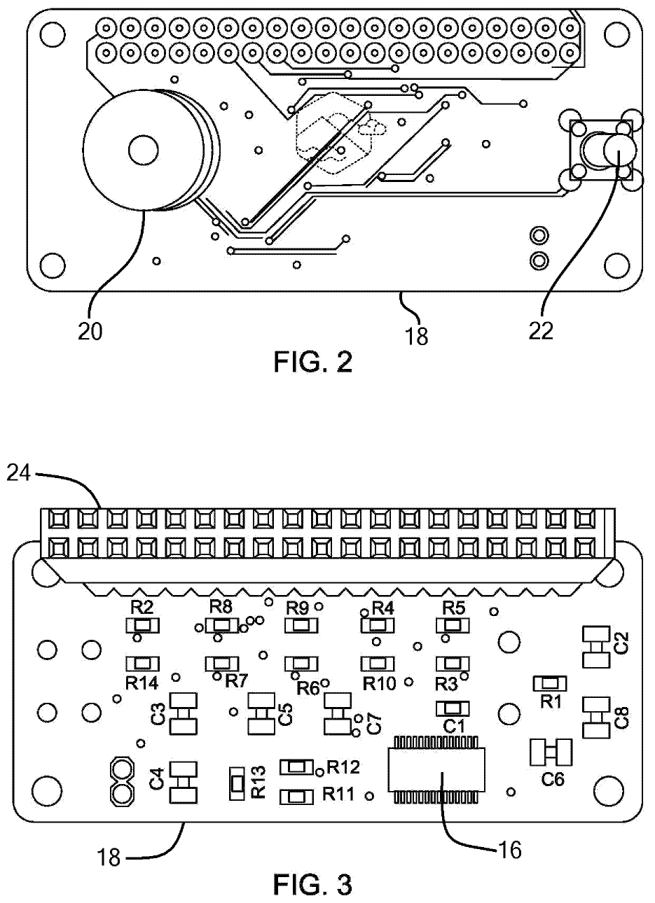

The custom-designed PCB 18 can be 66.0 mm long and 30.5 mm wide (see FIGS. 2 and 3), which can match the size of the single board computer 12 to make it convenient to stack the two boards for packaging. The PCB 18 can have two copper layers and can measure 1.6 mm thick. The PCB 18 can have the following circuits: (1) an input circuit that receives output signal from the geophone, (2) the ADC chip 16 and the supporting circuit, (3) a circuit for the buzzer alarm and button switch, (4) a 40-pin GPIO 24 to directly plug into the GIPO port (not shown) of the single board computer 12 for power, control signal, and ADC conversion data transfer. The digital, analog, and power supply circuits can be partitioned into separate sections of the PCB 18. In an exemplary embodiment, the ADC chip 16 and all the components were hand soldered onto the PCB 18. The ADC chip 16, resistors, and capacitors are all surface mount devices (SMD), which makes the PCB 18 easily manufacturable with automated soldering machines.

The housing 26 (also referred to as the packaging 26) is designed to be consumer friendly: small, robust and aesthetic. The overall packaging 26 can be palm-sized, measuring, for example, about 2.8 inches long, 2.8 inches wide, and 2 inches tall, with rounded corners (see FIG. 1). The packaging 26 can include layers of cast acrylic that are cut by a precision laser to enclose the components tightly (for example, holding the geophone 14 in place to minimize unintended vibration), while leaving enough room inside (for example, around the single board computer 12 and the custom-designed PCB 18) and creating openings to the outside for sufficient airflow to help moderate the system's temperature. The acrylic layers can be 1.5 mm, 3.0 mm, or 6.0 mm in thickness and can be assembled with, for example, M2.5×50 mm screws and standoffs. A bubble level 30 can be enclosed in the bottom acrylic layer to help ensure the device 10 is level.

The custom-developed software can be stored in a processor or memory of the single board computer 12 and can have three modules, all written in Python, for example. The first module manages the operation of the ADC 16. It can initiate the ADC 16, write to the ADC registers (to select input pins and set data sampling rate, PGA amplification, and other settings), perform offset calibration to remove signal baseline offset, read conversion data from the ADC 16 via an SPI serial interface, and conduct checksum verification to improve data integrity. The second software module can manage the operation of the single board computer 12, EEW functions, and user settings. It can compare the seismic signals from the ADC 16 to the threshold set by the user and can issue an alert when earthquake ground motion over the threshold is detected, triggering the onboard buzzer alarm 20 to beep loudly, and sending out text messages to all local subscribers. The text messages can be driven, for example, by an API with Twilio. Users can configurate software settings, such as alert threshold, data sampling rate, and subscriber telephone numbers. The system can be secured through the operating system secure login of the single board computer 12 and can be remotely managed through SSH secure network protocol, either through a smartphone or computer. The third software module can capture seismic waveform data, add time stamps using NTP (Network Time Protocol) in either UTC (Coordinated Universal Time) or local time, and save the data into industry standard mini SEED files that can be used with other seismology software for EEW or seismological studies. This third module can leverage ObsPy, for example, which is an open-source library for processing seismological data in Python.

A first prototype of the device was built on a breadboard and used a commercial ADS1262 ADC breakout board. The commercial ADC board contained the ADC chip and the supporting signal conditioning circuit. The first prototype used a Raspberry Pi® 4 Model B single board computer, which is the latest and most powerful model of Raspberry Pi®. For the second prototype 40, as shown in FIG. 4, it was confirmed that Raspberry Pi® Zero Wireless, which is significantly less expensive than Raspberry Pi® 4 Model B, can meet the application requirements. In addition, the commercial ADC board was replaced with the ADC chip and a custom-designed circuit 44, significantly lowering the cost. The breadboard was replaced with a protoboard 42 with soldered components to improve performance. Finally, the current device 10, as shown in FIG. 1, uses a custom-designed PCB, surface mount components, direct GPIO connection with the single board computer (Raspberry Pi® Zero Wireless), and a packaging with cast acrylic layers, which not only lowered cost to under $100, but also reduced device size and made it more robust.

### Results

The first test was to measure the noise performance of the EEW device 10. The noise baseline determines the smallest seismic signal that can be detected. In order to test the noise level of the ADC itself without external circuits, according to the datasheet from Texas Instruments®, the ADC inputs were shorted, ten seconds of consecutive ADC readings were taken, and noise level was calculated from the captured data. To test the ADC with the geophone and signal conditioning circuit connected, data from the ADC were captured again for ten seconds, from which noise level was calculated. All noise tests were conducted with custom-developed Python programs that controlled the Raspberry Pi® and the ADC.

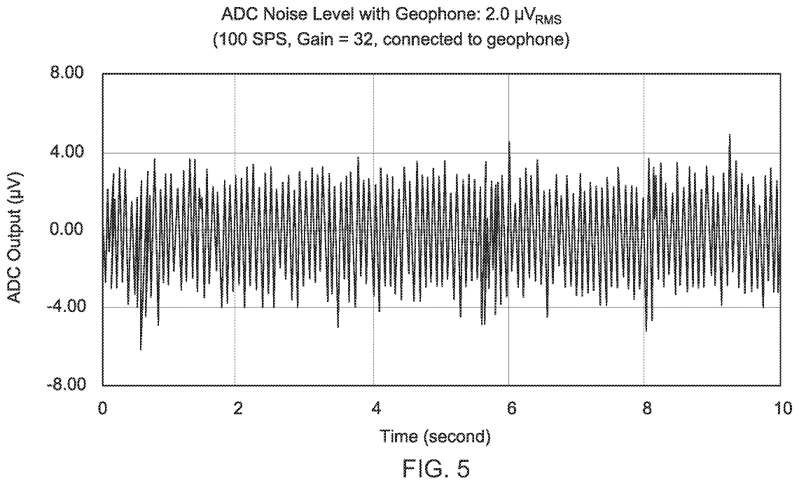

The IoT EEW device's standard sampling rate is 100 samples per second, and the PGA amplification ratio is 32 times. Under these settings, the measured noise baseline level for the ADC itself was 0.058 μV in RMS value, as shown in FIG. 5, which was consistent with the ADC's datasheet.

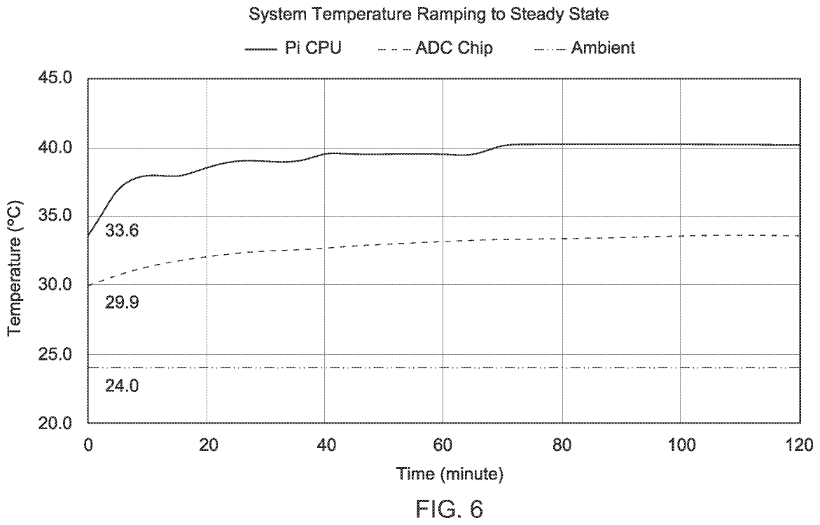

When the ADC was connected to the geophone and signal conditioning circuit, under the same settings, the measured noise level was 2.0 μV in RMS value, as shown in FIG. 6, which indicated that the geophone and circuit introduced significant amount of noise to the system. Generally, smaller noise is achieved with lower sampling rate and higher amplification ratio, when operating within the ADC's input range. Users can adjust sampling rate and amplification ratio settings through the device's custom software to meet different needs. For EEW applications, earthquake signals are relatively high compared to device noise, which is different than the requirement for teleseismic event detection, which has weak ground motion signals. Therefore, although there is room for improvement to further reduce noise level of the device, this work has not focused on minimizing noise, as the current noise level is sufficiently low for EEW applications.

The device 10 was also tested for temperature performance, given its small packaging and high sampling rate of 100 samples per second. The Raspberry Pi® has an operating temperature range of −40° C. to 85° C. The ADC chip has a larger operating temperature range of −40° C. to 125° C. Both the Raspberry Pi® CPU and the ADC chip have built-in temperature sensors that are accessible from programming. Given the ADC has a low package-to-PCB thermal resistance, the ADC temperature is also a good proxy for the PCB temperature. The device was tested for its temperature profile from power-up to continuous operation for 120 minutes, at a constant ambient temperature of 24° C. The standard sampling rate of 100 samples per second and PGA amplification ratio of 32 were used. All temperature tests were conducted with custom-developed Python programs that controlled the Raspberry Pi® and ADC.

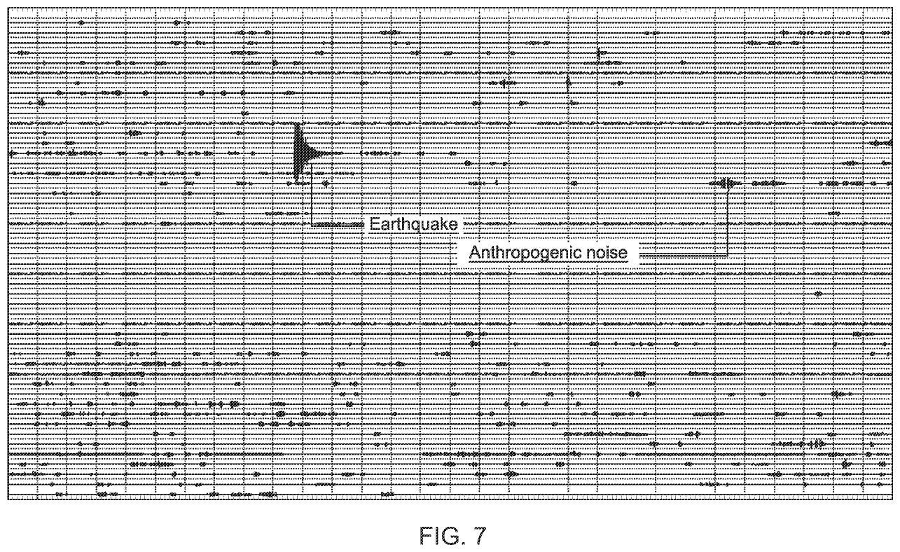

The temperature testing showed that both the Raspberry Pi® and ADC temperatures rose quickly after power-up but reached steady states of 40.1° C. and 33.6° C. respectively, then stayed at the same level for the rest of the testing, as shown in FIG. 7. This showed that the chips and boards were operating well within the specified temperature ranges. Even though the chips and boards were enclosed in the acrylic packaging, the hollow space created within the packaging as well as the openings to the outside provided sufficient airflow to moderate the operating temperature inside.

For performance testing in response to earthquakes, the device was placed on the first floor of a single-story house in the Los Angeles, Calif. metro area for continuous testing from September 2020 to early April 2021. Various alert settings were tested to determine the proper threshold for detecting earthquakes while avoiding false alarms. Cell phone numbers were collected from local pilot users who subscribed to the EEW warning service. Both the onboard buzzer alarm and text message alerts were tested.

During the testing period, there were 4 earthquakes over the magnitude of M 3.0 around the Los Angeles metro area: an M 4.5 earthquake on September 19 UTC about 40 km from the user testing site, an M 3.3 earthquake on September 21 UTC about 80 km from the user testing site, an M 3.2 earthquake on September 23 UTC about 80 km from the user testing site, and an M 3.4 earthquake on November 16 UTC about 100 km from the user testing site. All these earthquakes were detected by the IoT EEW device, which also successfully generated earthquake alert for the M 4.5 event which was over the user's alert threshold.

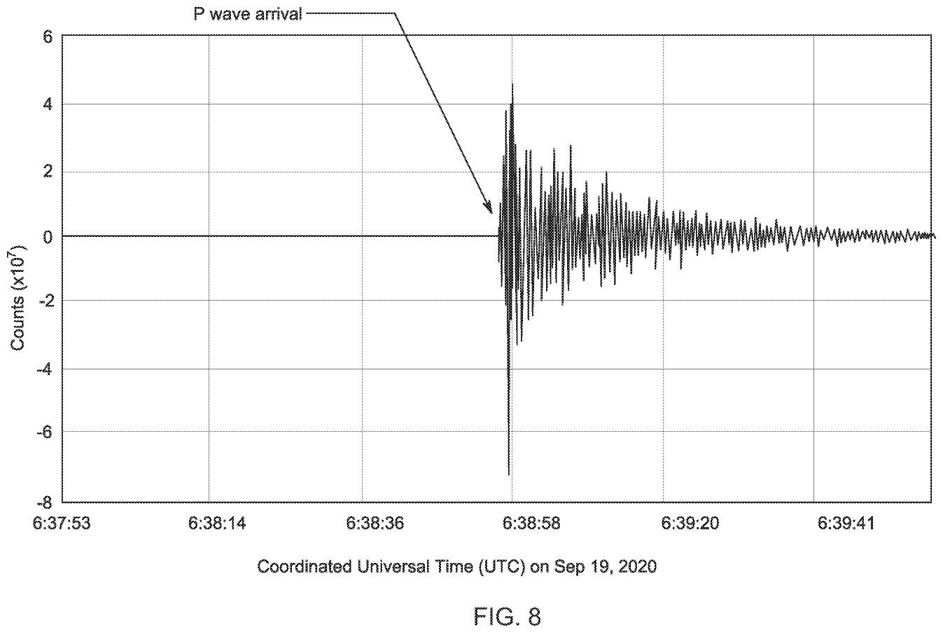

For the M 4.5 earthquake on Sep. 19, 2020 UTC, the seismic helicorder plot for the 24-hour period generated by the IoT EEW device is shown in FIG. 8, which clearly illustrates that the earthquake signal was significantly higher and longer than both the baseline noise of the system and the anthropogenic noises generated by human activities at or near the user's home.

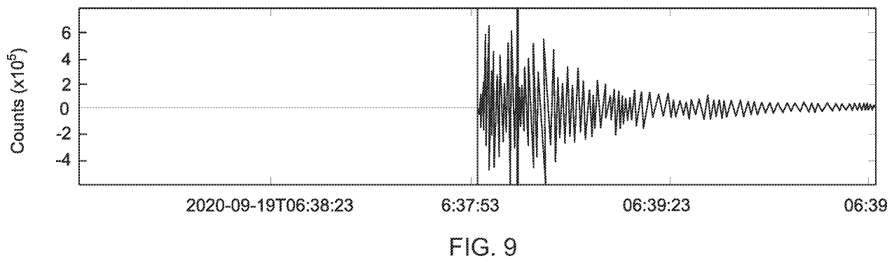

The seismic waveform chart of the M 4.5 earthquake generated by the IoT EEW device is shown in FIG. 9. The P wave arrived between 06:38:53 and 06:38:54 UTC, which was about 8 seconds after the earthquake onset time of 06:38:46.94 UTC at the epicenter about 40 km away. This suggests that the P wave traveled at around 6 to 7 km per second through the Los Angeles area.

After the earthquake events, for validation and comparison purposes, the seismic waveform data captured by the IoT EEW device were compared to those from a high-performance broadband seismometer at the nearest seismic station in the Southern California Seismic Network (SCSN). The nearest station in the network is RPV (Rancho Palos Verdes), which is located about 4 km from the user testing site. The RPV station has a broadband seismometer with model number STS-2 made by Streckeisen Seismic Instrumentation, which is triaxial but only the vertical channel waveforms were compared to the EEW device's vertical geophone's output. The waveform for the M 4.5 earthquake produced by the IoT EEW device, as shown in FIG. 9, was comparable with the vertical channel waveform from the nearest official broadband seismometer, as shown in FIG. 10, which helped to validate the device's output.

A spectrogram for the M 4.5 earthquake can be generated by the IoT EEW device to illustrate that the earthquake ground motions had significantly different frequency and energy profiles from the background noise, which can be used to help differentiate earthquake signals from noises.

The captured data for all earthquakes were successfully saved into standard mini-SEED files, which could be used for post-event research of the device performance or for seismological study of the earthquakes. The device's current 16 GB micro-SDHC card can store 1 to 4 years (depending on desired precision of saved data) of continuous data of ground motion in mini-SEED format.

A collection of the devices can be used to build an IoT network to improve regional EEW performance. The devices can have real-time communication among themselves and/or with the network hub. Ground motion data can be processed both at the network edge (i.e., on each device) and centrally through cloud computing to reduce latency.

Artificial intelligence (AI) machine learning algorithms can be developed to better differentiate actual earthquake signals from anthropogenic noise generated by human activities at the user's location.

In addition to sounding the alarm and sending text messages, the EEW alert signal can be integrated with other smart devices at user's location. For example, the alert signal can be used to automatically shut off utility lines, stopping trains, shut down elevators, alert first responders, sounding school alarms, and stop certain appliance and machinery.

In some embodiments, additional sensors, such as MEMS accelerometers and a GPS may be integrated with the device.

While a specific structural configuration has been shown and described, the selection of the specific hardware components can be fairly flexible with similar specifications to achieve the same goals. For example, the single-board computer, the analog-to-digital converter, the geophone, the buzzer, the button, the resistors and capacitors, and the like may be changed with similar components. The circuit design and printed circuit board design can have variations (e.g. with routing, resistor and capacitor values, etc.) to achieve the same goals. The packaging design or manufacturing (e.g. using injection molding or 3D printing instead of laser-cut acrylic layers) can be different but achieve the same goals. The device can be powered differently to achieve the same goals. For example, instead of plugging into a wall outlet, a battery or a solar panel can be part of the device. Further, additional functions can be conveniently added to the hardware platform. For example, accelerometer chips can be added for strong motion sensing, a GPS chip can be added for location sensing, and the like. The software coding can be modified to provide similar or additional functionalities based on the same hardware. For example, AI machine learning can be used to help the differentiation of actual earthquakes from human activities, or to identify which kinds of human activities e.g., walking or a vehicle passing nearby which can lead to other applications such as security.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for providing an early earthquake warning (EEW) to a user, comprising:
disposing an EEW device at a location;
detecting ground motion with a sensor geophone disposed in the EEW device; processing data from the sensor in an analog-to-digital converter (ADC) in the EEW device;
sending data from the ADC to a single board computer;
alerting the user of an event when ground motion is determined to be, by the single board computer, above a predetermined threshold or meeting predefined criteria; and
alerting other users of the event by sending out messages to respective computing devices of the other users.

2. The method of claim 1, wherein the method includes disposing a plurality of EEW devices at a plurality of locations, wherein the plurality of EEW devices communicate ground motion data, detected events, and/or commands with a central hub and/or with each other.

3. The method of claim 1, wherein the ADC is disposed on a printed circuit board, the printed circuit board electrically connected to the sensor, and the printed circuit board include an interface operable to connect to a computer interface of the single board computer.

4. The method of claim 3, wherein the step of alerting the user includes sounding a buzzer attached to the printed circuit board.

5. The method of claim 1, further comprising saving data of detected ground motion to a data card removably connected to the single board computer.

6. The method of claim 1, encasing the single board computer, the ADC and the sensor in a housing.

7. The method of claim 6, wherein the housing has dimensions of about 1.5 inches to about 4.0 inches in length, depth and height.

8. The method of claim 6, wherein the housing includes a plurality of openings to fluidly connect the ADC and the single board computer with an external environment or with at least one of a global positioning satellite (GPS) system, an ethernet adapter, a battery, or a power bank.

9. The method of claim 1, further comprising deactivating an alert by depressing a button on the EEW device or by sending a command via wireless communications or via the internet.

10. The method of claim 1, further comprising leveling the EEW device with a bubble level formed in a housing of the EEW device.

11. The method of claim 1, wherein the EEW device includes software, stored in non-tangible media, having program code configured to manage operations of the ADC, including program code configured to write to registers of the ADC, perform offset calibration to remove signal baseline offset, read conversion data from the ADC and conduct checksum verification for integrity of the read conversion data.

12. The method of claim 11, wherein the software further has program code configured to manage operations of the single board computer, including comparing conversion data from the ADC to the predetermined threshold or predefined criteria, triggering an alert, and sending messages to the other users.

13. The method of claim 12, wherein the software further has program code configured to capture seismic waveform data, add time stamps to the captured seismic waveform data, and save the data into files.

14. The method of claim 1, further comprising stopping or activating other devices or appliances, when ground motion is determined to be, by the single board computer, above the predetermined threshold or predefined criteria.

15. A method for providing an early earthquake warning (EEW) to a user, comprising:
disposing an EEW device at a location; detecting ground motion with a sensor disposed in the EEW device;
processing data from the sensor in an analog-to-digital converter (ADC) disposed on a printed circuit board in the EEW device;
sending data from the ADC to a single board computer disposed in the EEW device;
alerting the user of an event when ground motion is determined to be, by the single board computer, above a predetermined threshold or predefined criteria, the alarm including at least a buzzer disposed on the printed circuit board;
alerting other users of the event by sending out messages to respective computing devices of the other users; and
encasing the single board computer, the printed circuit board and the sensor in a single housing.

16. The method of claim 15, wherein the housing has dimensions of about 1.5 inches to about 4 inches in length, depth and height.

17. The method of claim 15, wherein the housing includes a plurality of openings to fluidly connect the ADC and the single board computer with an external environment.

18. An early earthquake warning (EEW) device comprising:
a printed circuit board having an analog-to-digital converter (ADC) disposed thereon;
an alert device disposed on the printed circuit board;
a single board computer coupled, via an interface, to the printed circuit board;
a sensor electrically connected to the printed circuit board; and
a housing containing the alert device, the single board computer, the sensor and the printed circuit board, wherein
the sensor detects ground motion and sends a motion signal to the ADC;
the ADC operates on the motion signal to send a converted signal to the single board computer;
the single board computer having a processor operable to compare the converted signal to a predetermined threshold or predefined criteria and to alert the user when the converted signal is above the predetermined threshold or the predefined criteria, indicating an earthquake or strong ground motion will occur at the user's location.

19. The EEW device of claim 18, the housing has dimensions of about 1.5 inches to about 4 inches in length, depth and height.

20. The EEW device of claim 18, wherein the housing includes a plurality of openings to fluidly connect the ADC, the printed circuit board, and the single board computer with an external environment.
